(19) United States
(12) Patent Application Publication
(10) Pub. No.: US 2024/0144073 A1
(43) Pub. Date: May 2, 2024

(54) FRAMEWORK FOR TRAINING DATA PROCUREMENT

(71) Applicant: SAP SE, Walldorf (DE)

(72) Inventors: Guilherme Ehrhardt S. FERREIRA COSTA, Lisbon (PT); Joao Pedro AMARAL SIMOES, Lisbon (PT)

(21) Appl. No.: 17/973,795

(22) Filed: Oct. 26, 2022

(51) Int. Cl. G06N 20/00

(52) U.S. Cl. CPC G06N 20/00

(57) ABSTRACT

Systems and methods provide determination of a model script for training a first machine learning model based on input training data, determination of a metrics script for determining one or more performance metric values associated with the trained first machine learning model based on validation data, and compilation of the model script and the metrics script into an executable file.

### BACKGROUND

Modern applications may use machine learning models to provide inferences to their users. A machine learning model is typically trained based on large amounts of historical “training” data, and the trained model is then used to generate inferences based on new data. The performance (e.g., accuracy) of a trained model is related to the amount and quality of the training data used to train the model.

An application developer working in an organization may train a machine learning model based on data owned by the organization or otherwise usable by the organization for such purposes. In the latter case, an organization may offer customers a cloud-based infrastructure for executing applications and may, with permission, use data stored by customers in such an infrastructure as training data. However, in many situations, training data which is suitable in amount and in quality is not readily available to a developer.

One approach for addressing the above is to purchase data from one or more external data providers. Prior to purchasing such data, it is desirable to determine a degree to which the data will be suitable for training the model for which it will be used. Suitability may be determined based on, for example, a degree of correspondence between the distribution of the training data and the data which is anticipated to be presented to the trained model during deployment, differences between the training data for purchase and data already possessed by the developer, and/or the representation of edge cases in the training data. In order to determine this suitability, the prospective purchaser would need to acquire the data, train a model using the data, and evaluate performance of the trained model.

A data provider is unlikely to provide its data for such evaluation prior to any purchase. Conversely, a machine learning model developer would likely not consent to providing a machine learning model to the data provider for training using its data. Instead, evaluation is limited to receiving a data sample from the data provider prior to purchase. The sample is too small to be used for model training and the feature distribution of the sample with respect to the entire dataset to be purchased is unknown.

Systems are desired to allow a machine learning model developer to evaluate the quality of training data with respect to a given machine learning model without requiring the developer to access the training data and without providing details of the model to the owner of the training data.

### BRIEF DESCRIPTION OF THE DRAWINGS

FIG. 1 is a block diagram of an architecture to evaluate training data of a data provider according to some embodiments.

FIG. 2 is a block diagram of an architecture to evaluate training data of two data providers according to some embodiments.

FIG. 3 is a flow diagram of a process to generate an executable file for evaluation of training data of a data provider according to some embodiments.

FIG. 4 is a flow diagram of a process of an executable file generated according to some embodiments.

FIG. 5 is a block diagram of an architecture to evaluate training data of one or more data providers using an intermediary procurement service according to some embodiments.

FIG. 6 represents a configuration of a procurement process and associated procurement process results according to some embodiments.

FIG. 7 represents a procurement process configuration instance, a model script and a metrics script according to some embodiments.

FIG. 8 illustrates execution of an executable file at a data provider and a corresponding procurement process results instance according to some embodiments.

FIG. 9 illustrates execution of an executable file at a data provider and a corresponding procurement process results instance according to some embodiments.

FIG. 10 is a block diagram of a cloud-based architecture implementing a system according to some embodiments.

### DETAILED DESCRIPTION

The following description is provided to enable any person in the art to make and use the described embodiments. Various modifications, however, will remain readily-apparent to those in the art.

Some embodiments efficiently facilitate evaluation of the quality of training data with respect to a given machine learning model without requiring the developer of the machine learning model to access the training data and without providing details of the model to the owner of the training data. In some aspects, the machine learning model that will be used is specified within a model script, the model performance metrics that will be used to judge model quality are specified within a metrics script, and the model script and the metrics script are compiled into an executable file which is sent to a data provider. The data provider executes the script with respect to its training data, resulting in generation of model performance metrics. The executable file may include validation data provided by the developer and which is used to generate the model performance metrics. The model performance metrics are provided to the developer and may be used to determine whether to purchase the training data of the data provider.

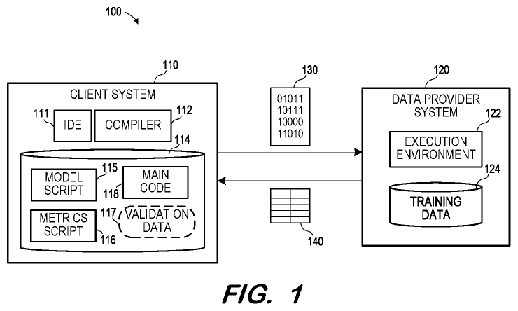

FIG. 1 is a block diagram of architecture 100 to provide enhanced machine learning model predictions according to some embodiments. Architecture 100 is a logical architecture and may be implemented any suitable combination of computing hardware and/or processor-executable program code that is or becomes known. Such combinations may include one or more programmable processors (microprocessors, central processing units, microprocessor cores, execution threads), one or more non-transitory electronic storage media, and processor-executable program code. In some embodiments, two or more elements of architecture 100 are implemented by a single computing device, and/or two or more elements of architecture 100 are co-located. One or more elements of architecture 100 may be implemented as a cloud service (e.g., Software-as-a-Service, Platform-as-a-Service) using cloud-based resources, and/or other systems which apportion computing resources elastically according to demand, need, price, and/or any other metric.

Client system 110 may comprise a computing device such as, but not limited to, a desktop computer, a laptop computer, a smartphone and a tablet computer. Client system 110 may store and execute program code of software applications such as integrated development environment 111 using which a user may author program code and scripts. Such scripts may include model script 115 and metrics script 116 stored in storage 114 (e.g., a hard drive). Storage 114 may also store validation data 117 for optional use as will be described below.

According to some embodiments, client system 110 executes compiler 112 to generate executable file 130. Executable file 130 may be executed to execute model script 115 and metrics script 116 in a manner orchestrated by main code 118. Executable file 130 may also include validation data 117, which is used during the execution as also specified by main code 118.

Data provider system 120 receives executable file 130. Data provider system 120 includes execution environment 122 (e.g., a Windows operating system) suitable for executing file 130, and stored training data 124. Training data 124 may be owned/managed by an operator of system 120 and available for purchase by third parties. Notably, executable file 130 is in binary format and therefore significantly obscures the details of model script 115, metrics script 116 and validation data 117 (if any) from an operator of data provider system 120.

According to some embodiments, an operator of system 120 initiates execution of file 130. In response, data provider system 120 asks the operator to indicate a location of a suitable set of training data 124. The operator may be prompted with information describing the semantics and format of a desired training data set, and may use this information to select a suitable set of training data 124.

System 120 continues to execute executable file 130 to acquire the indicated set of training data and to train a model based thereon by executing model script 115, embodied in the binary code of file 130. Metrics script 116 is then executed based on the trained model (i.e., a model artifact) generated by model script 115. Metrics script 116 requires validation data in order to validate performance of the trained model as is known in the art. This validation may comprise validation data 117 compiled within file 130 or, if not provided, may have been extracted from the indicated set of training data and not used for model training.

Metrics script 116 generates model performance metrics 140 based on the trained model and the validation data. Metrics 140 may comprise a value for each of one or more model performance metrics, including but not limited to accuracy and precision. The user of client system 110 may review metrics 140 to determine whether or not to purchase the training data of system 120, for example. Notably, the user receives the metrics 140 and may make an informed and model-specific purchasing decision without ever accessing or seeing any of training data 124 used to train the model and generate metrics 140.

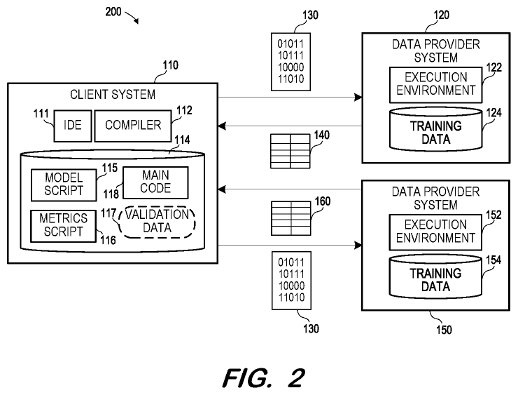

FIG. 2 is a block diagram of architecture 200 to evaluate training data of two data providers according to some embodiments. Architecture 200 is identical to architecture 100 except for the inclusion of data provider system 150. It will be assumed that systems 120 and 150 are associated with different data providers, and therefore training data 154 is different from training data 124.

As shown in FIG. 2, client system 110 provides a same executable file 130 to each of data provider systems 120 and 150. Advantageously, so long as execution environments 122 and 152 are capable of executing file 130, client system 110 need not generate a provider specific executable file. Rather, each data provider may execute a same executable file 130 to generate model performance metrics which are unique to its own training data. In this regard, execution of file 130 causes data provider system 150 to generate model performance metrics 160 which are unique to training data 154. The user of client system 110 may review metrics 140 and metrics 160 to determine whether to purchase training data from data provider system 120, from data provider system 150, or from neither.

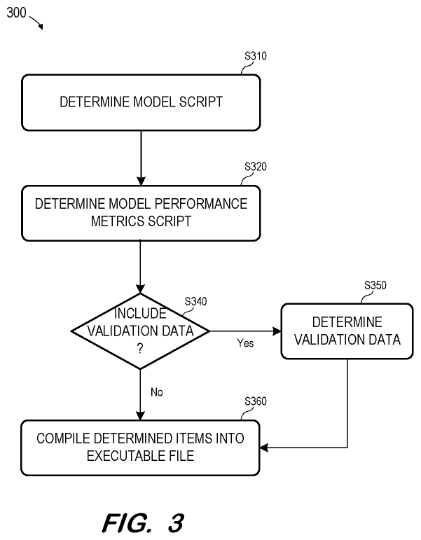

FIG. 3 illustrates process 300 to generate an executable file for evaluation of training data of a data provider according to some embodiments. Process 300 and the other processes described herein may be performed using any suitable combination of hardware and software. Processor-executable program code embodying these processes may be stored by any non-transitory tangible medium, including a fixed disk, a volatile or non-volatile random access memory, a DVD, a Flash drive, and a magnetic tape, and executed therefrom. Embodiments are not limited to the examples described below.

Initially, at S310, a model script is determined. The model script comprises an executable script for defining and training a machine learning model based on specified data. The model script may conform to any programming/scripting language that is or becomes known (e.g., python) so long as the language is interpretable by the compiler which will be used to create an executable file therefrom. The model script may be authored at S310 within a development environment or simply acquired from storage.

The model defined within the model script may comprise any algorithm which can be scripted (or imported) in the chosen programming/scripting language.

The model script determined at S310 is structured such that, when executed, the output of the execution is a model artifact (i.e., a trained model). The following pseudocode presents an example of a model script determined at S310 according to some embodiments, where MachineLearningAlgorithm( ) may comprise any algorithm which can be scripted (or imported) in the chosen programming/scripting language (e.g., Logistic Regression, NaiveBayes, autoregressive integrated moving average (ARIMA)).

```
  Input: TrainData in tabular format where the first n-1 columns are
features and the nth column is the target to predict using the model.
X_train = first n-1 columns in TrainData
y_train = last column in TrainData
model = MachineLearningAlgorithm( )
model.fit(X_train , y_train )
  Output: model
```

In some embodiments, the model script determined at S310 is a script for improving the performance of an existing trained model via incremental learning using data provided by a data provider. The particular model artifact which is input to such a script and the scripting language itself therefore support such incremental learning. The following pseudocode provides an example of such a model script.

Input: TrainData in tabular format where the first n-1 columns are
features and the nth column is the target to predict using the model.
X_train = first n-1 columns in TrainData
y_train = last column in TrainData
model.partial_fit(X_train , y_train )
Output: model

A model performance metrics script is then determined at S320. The model performance metrics (or metrics) script, when executed, computes performance metrics that will be used to judge the data used to train the model. The computed metrics may comprise any set of metrics that can be scripted (or imported) in the chosen language, including but not limited to accuracy, F1 score, and mean absolute percentage error.

According to some embodiments, the output of the metrics script is a set of key value pairs, where each key is a metric name and its value is the corresponding computed value of the metric. The following pseudo code provides an example of a metrics script according to some embodiments.

```
Input: PredictedData, ActualData, ListOfMetrics
RES = { }
  for f in ListOfMetrics :
    RES[f] = f(PredictedData,ActualData)
Output: RES
```

Next, at S340, it is determined whether the executable file to be provided to data providers is to include validation data. As described above, any provided validation data is intended to be used in conjunction with the metrics script to compute metric values. The determination at S340 may simply be based on whether a user has uploaded or otherwise designated validation data for inclusion in the executable file. If so, the validation data is determined (i.e., identified, acquired) at S350. and flow proceeds to S360. Whether or not validation is included, all determined items are compiled into an executable file at S360. The determined items may include a model script and a metrics script (if validation data was not included), or a model script, metrics script and validation data (if otherwise).

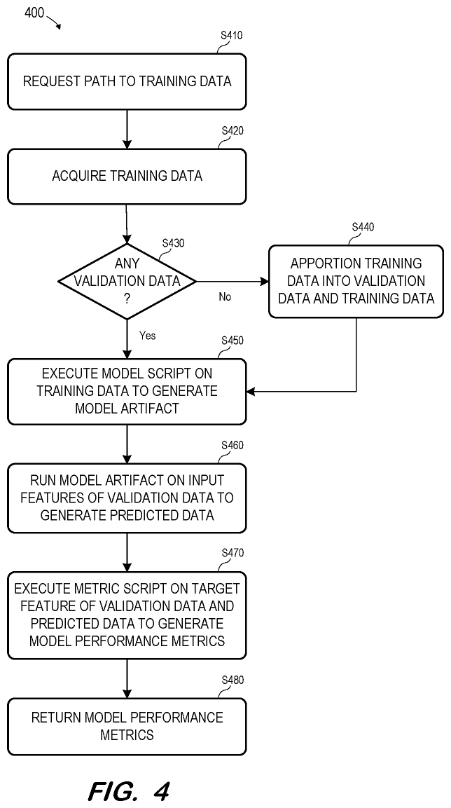

FIG. 4 illustrates process 400 according to some embodiments. Process 400 is performed by a computing system which executes the executable file generated at S360 of process 300. Accordingly, the compilation at S360 utilizes not only a model script, a metrics script and possibly validation data, but also program code which orchestrates the execution and use thereof in a manner to generate model performance metrics without intervention by an operator (other than to specify the training data).

Prior to process 400, an operator of a data provider system initiates execution of an executable file compiled as described above. Then, at S410, a path to training data is requested. In response to the request, the operator specifies a filepath to a set of training data. The set of training data may comprise a.csv file in some embodiments. The training data may reside on a storage system local to or remote from the data provider system and should be formatted as required by the model associated with the executable file (e.g., with respect to the number of features and the column location of the target feature).

The training data is acquired at S420 from the provided path. It is then determined at S430 whether any validation data is included in the executable file. If not, the acquired training data is apportioned into a set of training data and a set of validation data at S440. In one example, a random 80% of the acquired training data is designated as training data at S440 and the remaining 20% is designated as validation data. Flow proceeds to S450 after S440 or after S430 if validation data was included in the executable file.

The model script is executed on the training data to generate a model artifact at S450 as mentioned above and as is known in the art. The model artifact is a trained model which may be used to generate inferences. Accordingly, the model artifact is executed using the input features of the validation data (i.e., provided or apportioned) to generate predicted data at S460. The predicted data consists of inferences generated by the model artifact based on the input features of each instance (e.g., row) of the validation data.

Next, at S470, the metric script is executed based on the target feature of the validation data (i.e., the actual ground truth of each instance of the validation data) and the predicted data generated at S450 to generate model performance metrics. The model performance metrics may generally provide various characterizations of the difference between the target features and the predicted data as is known in the art. Finally, at S480, the model performance metrics are returned to the system from which the executable file was received (e.g., the potential training data purchaser).

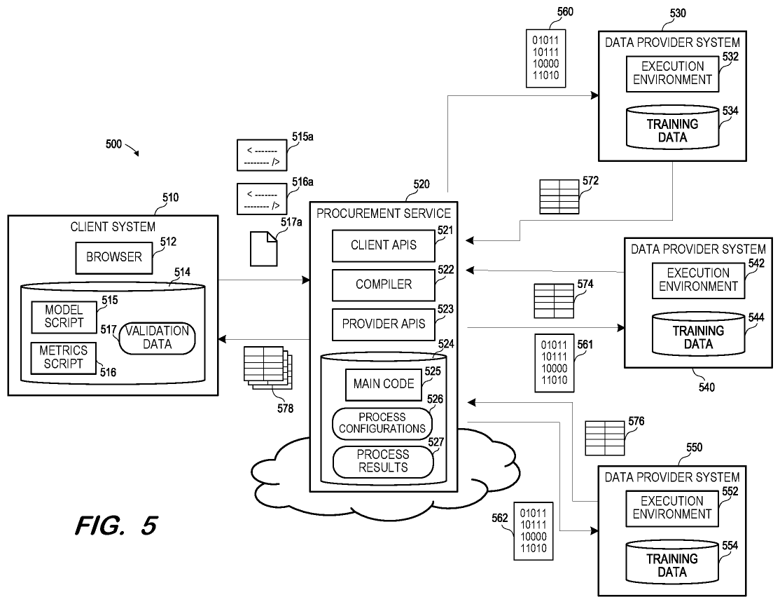

FIG. 5 illustrates centralized architecture 500 for efficiently generating and distributing executable files and aggregating model performance metrics according to some embodiments.

According to architecture 500, client system 510 interacts with procurement service 520 to generate a process configuration instance. A process configuration instance represents a request for particular model performance metrics associated with a particular model. Procurement service 520 may use a process configuration instance to generate and transmit an executable file associated with such a request to several different data providers specified within the process configuration instance.

Procurement service 520 may comprise any suitable monolithic, distributed, on-premise and/or cloud-based computing platform for executing program code. Procurement service 520 may implement client application programming interfaces (APIs) 521 which may be called by browser 512 executing within client system 510 to create a process configuration instance. Procurement service 520 may store such process configuration instances within process configurations 526 of storage system 524.

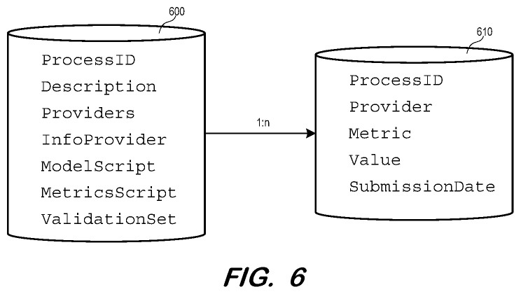

More particularly, client system 510 may execute browser 512 to call one or more of client APIs 521 in order to upload model script 515a, metrics script 516a and validation 517a of a particular process configuration instance to procurement service 520. FIG. 6 illustrates data model 600 of a process configuration according to some embodiments. As shown, process configuration model 600 includes fields associated with a model script, a metrics script and validation data. Model 600 also allows client system 510 to specify a process identifier, a process description, a list of data providers, and information to be provided to the data providers.

Procurement service 520 may generate and transmit executable files to data providers based on a process configuration instance of process configuration model 600 stored in process configurations 526. For example, compiler 522 generates an executable file based on the model script, the metrics script and the validation data specified in the process configuration instance and on main code 525. Compiler 522 also uses the data providers identified within the instance to generate a different executable file for each of the identified ones of data provider systems 530, 540 and 550.

Each different executable file includes a reference to the data provider to which the executable file is sent. This reference is used within the results returned by the executing file in order to identify the data provider from which the results were returned. For example, the following pseudocode illustrates execution of the executable file according to some embodiments.

```
Input: ProcessId, ProviderId, ModelScript, MetricsScript,
ListOfMetrics, ValidationData (optional)
Step 1 - prepare data
    print(′Enter path for your data:’)
    path = input( )
      TrainData = open(path)
    if Validation Data does not exist:
        TrainData = 80% randomly chosen records from TrainData
        ValidationData = remaining 20% records from TrainData
  Step 2 - create model
      Model = ModelScript(TrainData)
  Step 3 - run model
      PredictedData=Model.fit(first n-1 colums of ValidationData)
      ActualData=Model.fit(last column of ValidationData)
Step 4 - compute metrics
      Metrics = MetricsScript(PredictedData″, ″ ActualData,
      ListOfMetrics)
Step 5 - return results
      requests.post(url, json={ProcessId, ProviderId, Metrics})
```

Each respective data provider system 530-550 may call an API of provider APIs 523 to download a respective executable file 560-562. Also downloaded to each specified data provider is the specified information (i.e., InfoProvider) of the corresponding process configuration instance, which may describe the required input features and target feature of the requested training data. As illustrated by the above pseudocode, execution of a respective executable file causes a data provider system to call an API of provider APIs 523 to post the generated performance metrics. The call also passes the process identifier of the process configuration instance and an identifier of the calling data provider system. Procurement service 520 may store the returned information in process results 527.

Accordingly, client system 510 may call appropriate ones of client APIs 521 to access desired ones 578 of process results 527 based on a corresponding process identifier. As shown in FIG. 6, n instances of result model 610 may exist for each instance of process configuration model 600, where each instance shares a same process identifier. Result model 610 also includes fields for storing a provider identifier, an array of metrics and corresponding values, and a submission date.

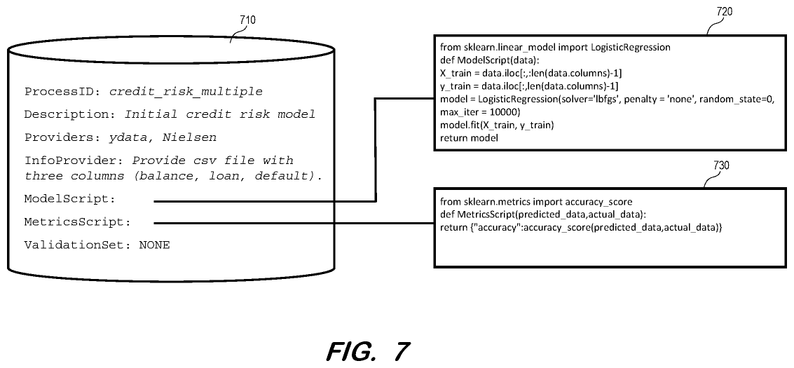

FIG. 7 represents procurement process configuration instance 710, model script 720 and metrics script 730 according to some embodiments. Instance 710 includes data associated with the above-described fields of process configuration 600. As shown, procurement process configuration instance 710 does not specify any validation data.

The data includes model script 720 and metrics script 730. The values and scripts of instance 710 may be provided to a data procurement service by a model developer as described above. The data procurement service may compile an executable file for each data provider specified in instance 710 (i.e., ydata, Nielsen).

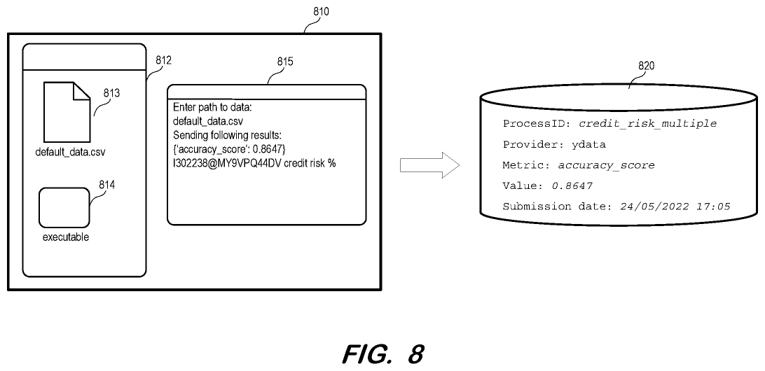

FIG. 8 illustrates execution of an executable file at a data provider and according to some embodiments. User interface 810 is displayed by a computing system of a data provider and includes window 812 of a file explorer application and execution window 815. Window 812 displays the contents of a folder which includes training data 813 of the data provider and executable file 814 which was compiled for the particular data provider based on instance 710 and downloaded from a procurement service.

The data provider initiates execution of file 814 and window 815 is displayed in response. Window 815 requests a path to the training data of the data provider and the path is input by the data provider. Embodiments may utilize any other suitable metaphor for providing data as input to an executable process.

After receiving the path to the training data, file 814 executes as described with respect to S420 through S480 to generate results instance 820 and return instance 820 to the procurement service. In the present example, window 815 also displays the determined metric values.

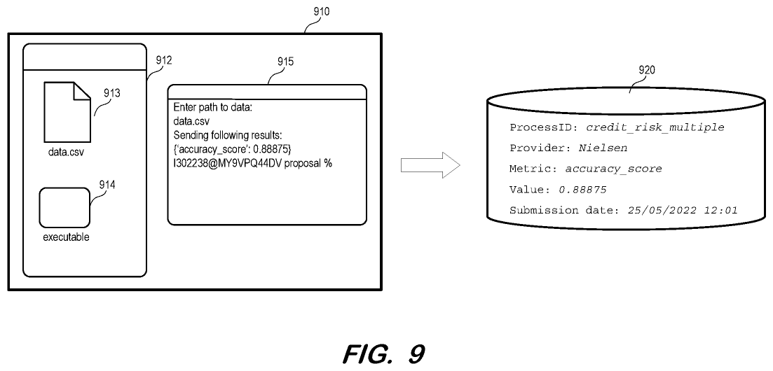

FIG. 9 illustrates execution of an executable file based on instance 710 at a second data provider and corresponding procurement process results instance 920 according to some embodiments. User interface 910 is displayed by a computing system of the second data provider (i.e., Nielsen) and includes window 912 of a file explorer application and execution window 915. Window 912 displays the contents of a folder which includes training data 913 of the second data provider and executable file 914. Executable file 914 was compiled for the second data provider based on instance 710 and downloaded from a procurement service.

The second data provider initiates execution of file 914 and window 915 is displayed in response. The second data provider provides a path to training data 913 and file 914 executes to generate results instance 920 and return instance 920 to the procurement service. As described above, the model developer may then download instances 820 and 920 from the procurement service to review the metric values determined based on the training data of each particular data provider.

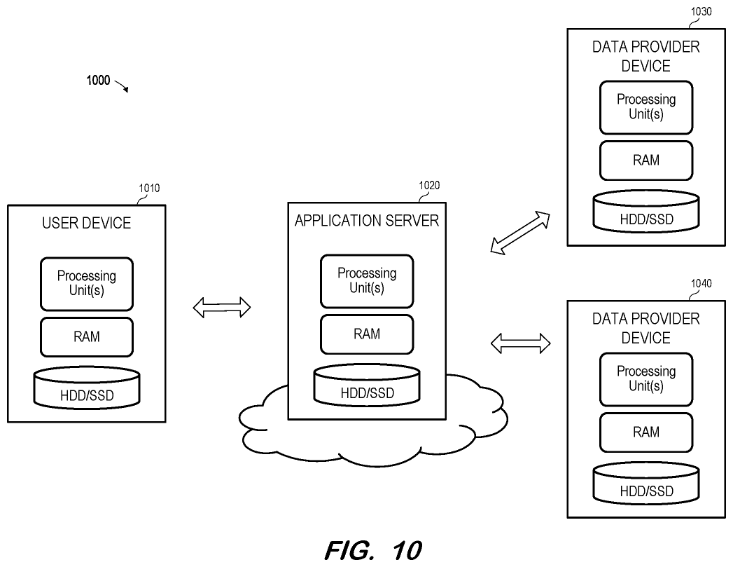

FIG. 10 is a block diagram of cloud-based architecture 1000 according to some embodiments. A user may operate user device 1010 to interact with user interfaces of a data procurement service or application provided by application server 1020. Application server 1020 may comprise cloud-based compute resources, such as one or more virtual machines, allocated by a public cloud provider providing self-service and immediate provisioning, autoscaling, security, compliance and identity management features.

User device 1010 may upload model scripts, metric scripts, validation data and other process configuration information via the user interfaces provided by application server 1020. Similarly, each of data provider devices 1030 and 1040 may interact with user interfaces of a data procurement service or application provided by application server 1020 to download executable files therefrom and return model performance metrics thereto.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of architectures described herein may include a programmable processor to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid-state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

What is claimed is:

1. A system comprising:
a storage device; and
a processing unit to execute processor-executable program code stored on the storage device to cause the system to:
determine a model script for training a first machine learning model based on input training data;
determine a metrics script for determining one or more performance metric values associated with the trained first machine learning model based on validation data; and
compile the model script and the metrics script into an executable file.

2. A system according to claim 1, the processing unit to execute processor-executable program code stored on the storage device to cause the system to:
provide the executable file to a first data provider to execute the executable file based on first training data of the first data provider to generate performance metric values associated with the first training data; and
receive the performance metric values associated with the first training data.

3. A system according to claim 2, the processing unit to execute processor-executable program code stored on the storage device to cause the system to:
provide the executable file to a second data provider to execute the executable file based on second training data of the second data provider to generate second performance metric values associated with the second training data; and
receive the second performance metric values associated with the second training data.

4. A system according to claim 1, wherein compilation of the model script and the metrics script into an executable file comprises compilation of the model script, the metrics script and the validation data into the executable file.

5. A system according to claim 1, the processing unit to execute processor-executable program code stored on the storage device to cause the system to:
determine a first data provider and a second data provider,
wherein compilation of the model script and the metrics script into an executable file comprises:
compilation of the model script and the metrics script into a first executable file associated with the first data provider; and
compilation of the model script and the metrics script into a second executable file associated with the second data provider,
wherein the first executable file and the second executable file are not identical.

6. A system according to claim 5, the processing unit to execute processor-executable program code stored on the storage device to cause the system to:
provide the first executable file to the first data provider to execute the first executable file based on first training data of the first data provider to generate first performance metric values associated with the first training data;
provide the second executable file to a second data provider to execute the second executable file based on second training data of the second data provider to generate second performance metric values associated with the second training data;
receive the first performance metric values associated with the first training data; and
receive the second performance metric values associated with the second training data.

7. A system according to claim 6, wherein compilation of the model script and the metrics script into the first executable file comprises compilation of the model script, the metrics script and the validation data into the first executable file, and
wherein compilation of the model script and the metrics script into the second executable file comprises compilation of the model script, the metrics script and the validation data into the second executable file.

8. A computer-implemented method comprising:
determining a model script for training a first machine learning model;
determining a metrics script for determining one or more performance metric values associated with the trained first machine learning model based on validation data, and for returning the determined one or more performance metric values; and
compiling the model script and the metrics script into an executable file.

9. A method according to claim 8, further comprising:
providing the executable file to a first data provider to execute the executable file based on first training data of the first data provider to generate performance metric values associated with the first training data; and
receiving the performance metric values associated with the first training data.

10. A method according to claim 9, further comprising:
providing the executable file to a second data provider to execute the executable file based on second training data of the second data provider to generate second performance metric values associated with the second training data; and
receiving the second performance metric values associated with the second training data.

11. A method according to claim 8, wherein compilation of the model script and the metrics script into an executable file comprises compiling the model script, the metrics script and the validation data into the executable file.

12. A method according to claim 8, further comprising:
determining a first data provider and a second data provider,
wherein compilation of the model script and the metrics script into an executable file comprises:
compiling the model script and the metrics script into a first executable file associated with the first data provider; and
compiling the model script and the metrics script into a second executable file associated with the second data provider,
wherein the first executable file and the second executable file are not identical.

13. A method according to claim 12, further comprising:
providing the first executable file to the first data provider to execute the first executable file based on first training data of the first data provider to generate first performance metric values associated with the first training data;
providing the second executable file to a second data provider to execute the second executable file based on second training data of the second data provider to generate second performance metric values associated with the second training data;
receiving the first performance metric values associated with the first training data; and
receiving the second performance metric values associated with the second training data.

14. A method according to claim 13, wherein compiling the model script and the metrics script into the first executable file comprises compiling the model script, the metrics script and the validation data into the first executable file, and
wherein compiling the model script and the metrics script into the second executable file comprises compiling the model script, the metrics script and the validation data into the second executable file.

15. A non-transitory medium storing processor-executable program code, the program code executable to cause a system to:
determine a model script for training a first machine learning model;
determine a metrics script for determining one or more performance metric values associated with the trained first machine learning model, and for returning the determined one or more performance metric values; and
compile the model script and the metrics script into an executable file.

16. A medium according to claim 15, the program code executable to cause a system to:
provide the executable file to a first data provider to execute the executable file based on first training data of the first data provider to generate performance metric values associated with the first training data; and
receive the performance metric values associated with the first training data.

17. A medium according to claim 16, the program code executable to cause a system to:
provide the executable file to a second data provider to execute the executable file based on second training data of the second data provider to generate second performance metric values associated with the second training data; and
receive the second performance metric values associated with the second training data.

18. A medium according to claim 15, wherein compilation of the model script and the metrics script into an executable file comprises compiling the model script, the metrics script and validation data for determining the one or more performance metric values into the executable file.

19. A medium according to claim 15, the program code executable to cause a system to:
determine a first data provider and a second data provider,
wherein compilation of the model script and the metrics script into an executable file comprises:
compilation of the model script and the metrics script into a first executable file associated with the first data provider; and
compilation of the model script and the metrics script into a second executable file associated with the second data provider,
wherein the first executable file and the second executable file are not identical.

20. A medium according to claim 19, the program code executable to cause a system to:
provide the first executable file to the first data provider to execute the first executable file based on first training data of the first data provider to generate first performance metric values associated with the first training data;
provide the second executable file to a second data provider to execute the second executable file based on second training data of the second data provider to generate second performance metric values associated with the second training data;
receive the first performance metric values associated with the first training data; and
receive the second performance metric values associated with the second training data,
wherein compilation of the model script and the metrics script into the first executable file comprises compilation of the model script, the metrics script and validation data for determining the first performance metric values into the first executable file, and
wherein compilation of the model script and the metrics script into the second executable file comprises compilation of the model script, the metrics script and validation data for determining the second performance metric values into the second executable file.
